(19) United States
(12) Patent Application Publication
(10) Pub. No.: US 2010/0053779 A1
(43) Pub. Date: Mar. 4, 2010

(54) DIGITAL PRESENTER USING GOOSENECK

(75) Inventor: I-Liang KAO, Jhubei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: LUMENS DIGITAL OPTICS INC., Jhubei City (TW)

(21) Appl. No.: 12/266,157

(22) Filed: Nov. 6, 2008

(30) Foreign Application Priority Data
Aug. 29, 2008 (TW) 097215608

(51) Int. Cl. G02B 7/02

(52) U.S. Cl. 359/811

(57) ABSTRACT

A digital presenter is provided. A digital presenter including a base; a lens; a gooseneck having one end secured to the base and the other end connected to the lens; and a supporting element having one end secured to the base and disposed inside the gooseneck, wherein the supporting element reinforces a supporting force for the gooseneck.

### FIELD OF THE INVENTION

The present invention relates to a gooseneck structure, in particular to a digital presenter having gooseneck structure.

### BACKGROUND OF THE INVENTION

Please referring to FIG. 1, which is a side view diagram illustrating a conventional digital presenter. In FIG. 1, the conventional digital presenter 1 consists essentially of a base 11, a conventional gooseneck 12 and a camera lens 13. Besides, depending on the requirements, an extra illuminating light 15 that is supported by the conventional gooseneck 12 is disposed on the base 11.

In the conventional prior art, an elastic metal is usually used for fabricating the conventional gooseneck 12. However, in such conventional fabricating scheme, the conventional gooseneck 12 is typically hollow. That is, the conventional gooseneck 12 consists essentially of a hollow and helical metal tube having elastic, so that the camera lens 13 could be well supported at whatever angle adjusted by the conventional gooseneck 12, since the metal used for fabricating the conventional gooseneck 12 has well elasticity.

However, after a long-term use, due to the metal fatigue, the conventional gooseneck 12 could hardly provide a stable supporting force at some certain angles that might be required to be used by a user, which results in inconvenience for the user. In the mean time, the conventional digital presenter 1 loses its useable value.

### SUMMARY OF THE INVENTION

Therefore, the inventor figures out a digital presenter with gooseneck structure that could provide more stable supporting force and more durable duration as compared with the above-mentioned conventional gooseneck.

In accordance with a first aspect of the present invention, a digital presenter including a base; a lens; a gooseneck having one end secured to the base and the other end connected to the lens; and a supporting element having one end secured to the base and disposed inside the gooseneck, wherein the supporting element reinforces a supporting force for the gooseneck is provided.

Preferably, the supporting element further includes a helical rod having one end secured to the base; and a helical tube covering the helical rod.

Preferably, the helical rod is made of an elastic metal.

Preferably, the helical tube is made of an elastic metal.

Preferably, the supporting element is made of an elastic metal.

Preferably, the supporting element is made of an elastic material.

Preferably, the supporting element has a length of at least one third of a length of the gooseneck.

In accordance with a second aspect of the present invention, a digital presenter, including a base; a reinforced gooseneck having one end secured to the base and an elastic support disposed therewith; and a lens connected to the reinforced gooseneck is provided.

The foregoing and other features and advantages of the present invention will be more clearly understood through the following descriptions with reference to the drawing, wherein:

### BRIEF DESCRIPTION OF THE DRAWINGS

FIG. 1 is a side view diagram illustrating a conventional digital presenter;

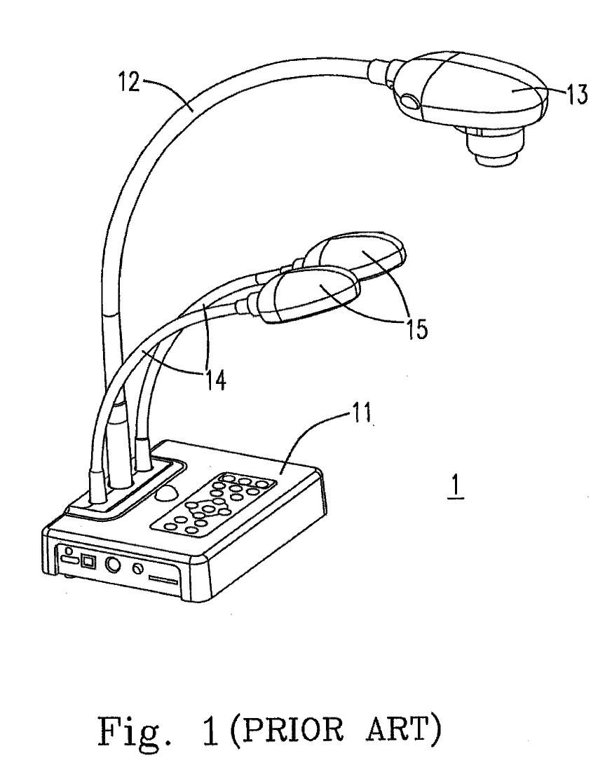

FIG. 2 is a perspective diagram illustrating a digital presenter with the gooseneck according to the present invention; and

FIG. 3 is a magnified diagram illustrating the tube 221 in FIG. 2.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

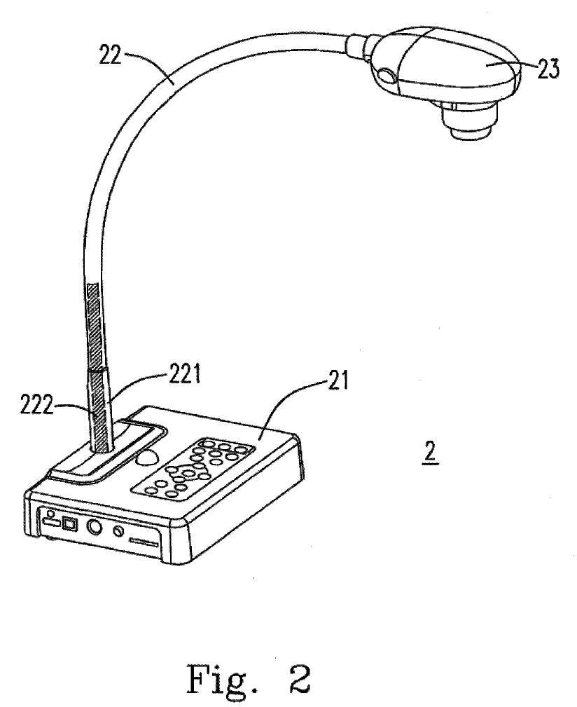

Please referring to FIG. 2, which is a perspective diagram illustrating a digital presenter with the gooseneck according to the present invention. In FIG. 2, the digital presenter 2 includes a base 21, a gooseneck 22 and a camera lens 23. In this embodiment, the gooseneck 22 includes a tube 221 and a support 222 inside the tube 221. One end of the tube 221 is secured to the base 21. One end of the support 222 is also secured to the base 21 of the digital presenter 2, so as to reinforce the supporting force relative to the base 21 provided by the gooseneck 22 when the gooseneck 22 is adjusted.

Furthermore, for the embodiment illustrated in FIG. 2, since the tube 221 and the support 222 that is rod-like respectively consist essentially of the elastic metal or the elastic material, an extra supporting force could be provided by the support 222 to efficiently reinforce the supporting force relative to the base 21 provided by the gooseneck 22 at whatever angle adjusted by the gooseneck 22. Hence, the structure of the gooseneck 22 of the digital presenter 2 according to the present invention could provide more stable supporting force and more durable duration as compared with the conventional gooseneck. A preferred data obtained from the experiments shows that the support 222 preferably has a length of at least one third of a length of the gooseneck 22.

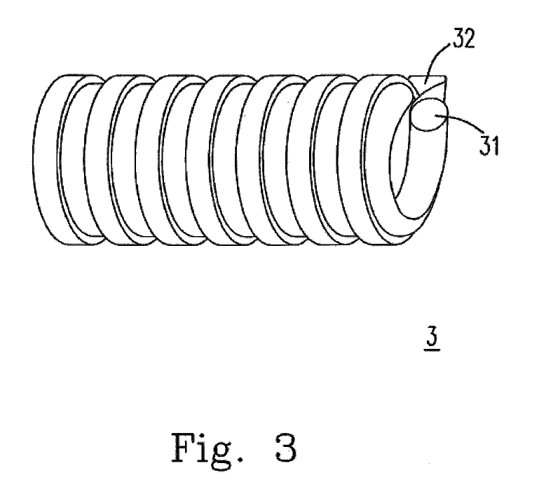

Please referring to FIG. 3, which is a magnified diagram illustrating the tube 221 in FIG. 2. In FIG. 3, the tube 221 is given a new reference symbol as 3. The tube 3 consists essentially of a helical rod 31 and a helical tube 32. As shown in FIG. 3, the helical rod 31 is a metal-made rod screwed in a helical shape. There is a gap that is covered by the helical tube 32 with a nearly triangular cross-section between each helixes of the helical rod 31. Such fabricating scheme could further reinforce the supporting force provided by the tube 3. The support 222 is inserted into the central hollow tunnel tube 3 and is secured to the base 11, such that the gooseneck formed thereaccording could provide more stable supporting force and more durable duration as compared with the conventional gooseneck.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A digital presenter, comprising:
a base;
a camera lens;
a gooseneck having one end secured to the base and the other end connected to the lens; and
a supporting element having one end secured to the base and disposed inside the gooseneck,
wherein the supporting element reinforces a supporting force for the gooseneck.

2. The digital presenter according to claim 1, wherein the supporting element further comprises:
a helical rod having one end secured to the base; and
a helical tube covering the helical rod.

3. The digital presenter according to claim 2, wherein the helical rod is made of an elastic metal.

4. The digital presenter according to claim 2, wherein the helical tube is made of an elastic metal.

5. The digital presenter according to claim 1, wherein the supporting element is made of an elastic metal.

6. The digital presenter according to claim 1, wherein the supporting element is made of an elastic material.

7. The digital presenter according to claim 1, wherein the supporting element has a length of at least one third of a length of the gooseneck.

8. A digital presenter, comprising:
a base;
a reinforced gooseneck having one end secured to the base and an elastic support disposed therewith; and
a lens connected to the reinforced gooseneck.
